(19) United States
(12) Patent Application Publication
(10) Pub. No.: US 2009/0260698 A1
(43) Pub. Date: Oct. 22, 2009

(54) PRESSURE CONTROL SYSTEM

(75) Inventor: Roger Suter, Katy, TX (US)

Correspondence Address: OSHA LIANG/MI, TWO HOUSTON CENTER, 909 FANNIN STREET, SUITE 3500, HOUSTON, TX, 77010, US

(73) Assignee: M-I LLC, Houston, TX (US)

(21) Appl. No.: 12/104,106

(22) Filed: Apr. 16, 2008

(51) Int. Cl. F16K 31/12; F16K 47/04

(52) U.S. Cl. 137/509; 251/63

(57) ABSTRACT

A fluid control system, including: a housing having an inlet, an outlet, and a pressure chamber; a shuttle assembly adapted to reciprocate in the pressure chamber to regulate the flow of an operating fluid from the inlet to the outlet; the operating fluid applying an opening force to a first end of the shuttle assembly; a control fluid to apply a closing force to an opposite end of the shuttle assembly; wherein an operating fluid pressure area of the first end of the shuttle assembly when in a closed position is at least 65 percent of the operating fluid pressure area of the first end of the shuttle assembly when in an open position.

### BACKGROUND OF DISCLOSURE

1. Field of the Disclosure

Embodiments disclosed herein relate generally to a fluid control system. More specifically, embodiments disclosed herein relate to a pressure control system having a reduced contact area between upstream (dynamic) and downstream (static) components, such as between a shuttle nut and a valve seat or static trim, resulting in a reduced pressure overshoot required for initially moving the dynamic components from a closed position.

2. Background

There are many applications in which there is a need to control the back pressure of a fluid flowing in a system. For example, in the drilling of oil wells it is customary to suspend a drill pipe in the well bore with a bit on the lower end thereof and, as the bit is rotated, to circulate a drilling fluid, such as a drilling mud, down through the interior of the drill string, out through the bit, and up the annulus of the well bore to the surface. This fluid circulation is maintained for the purpose of removing cuttings from the well bore, for cooling the bit, and for maintaining hydrostatic pressure in the well bore to control formation gases and prevent blowouts, and the like. In those cases where the weight of the drilling mud is not sufficient to contain the bottom hole pressure in the well, it becomes necessary to apply additional back pressure on the drilling mud at the surface to compensate for the lack of hydrostatic head and thereby keep the well under control. Thus, in some instances, a back pressure control device is mounted in the return flow line for the drilling fluid.

Back pressure control devices are also necessary for controlling “kicks” in the system caused by the intrusion of salt water or formation gases into the drilling fluid which may lead to a blowout condition. In these situations, sufficient additional back pressure must be imposed on the drilling fluid such that the formation fluid is contained and the well controlled until heavier fluid or mud can be circulated down the drill string and up the annulus to kill the well. It is also desirable to avoid the creation of excessive back pressures which could cause the drill string to stick, or cause damage to the formation, the well casing, or the well head equipment.

However, maintenance of an optimum back pressure on the drilling fluid is complicated by variations in certain characteristics of the drilling fluid as it passes through the back pressure control device. For example, the density of the fluid can be altered by the introduction of debris or formation gases, and/or the temperature and volume of the fluid entering the control device can change. Therefore, the desired back pressure will not be achieved until appropriate changes have been made in the throttling of the drilling fluid in response to these changed conditions. Conventional devices, such as a choke, generally require manual control of and adjustments to the back pressure control device orifice to maintain the desired back pressure. However, manual control of the throttling device involves a lag time and generally is inexact.

U.S. Pat. No. 4,355,784 discloses an apparatus and method for controlling back pressure of drilling fluid in the above environment which addresses the problems set forth above. According to this arrangement, a substantially balanced shuttle moves in a housing to control the flow and the back pressure of the drilling fluid. One end of the shuttle assembly is exposed to the pressure of the drilling fluid and its other end is exposed to the pressure of a control fluid.

U.S. Pat. No. 6,253,787 discloses a choke device that operates automatically to maintain a predetermined back pressure on the flowing fluid despite changes in fluid conditions. As described therein, to maintain accurate control of the back pressure applied during shuttling, a back pressure may be exerted on the shuttle assembly by a control fluid. The pressure of the fluid in the inlet passage acts on a corresponding end of the shuttle assembly with the same force imposed on the other end of the shuttle assembly by the control fluid.

Referring now to FIG. 1, a prior art design of a back pressure control system 10 having a nut 50 is illustrated, similar to that as illustrated in FIG. 1 of U.S. Pat. No. 7,004,448. During shuttling, the pressure of operating fluid in chamber 16 may act on the surface 50a and any exposed surface at the end of shuttle 40. The forces applied to shuttle nut 50 and shuttle 40 by the operating fluid in chamber 16 may be balanced with the pressure of a control fluid in chambers 46a, 46b.

While sufficient for balancing pressures during shuttling, when the shuttle assembly is in a fully closed position, surface 50a abuts surface 70 of the static trim and other downstream components, such that operating fluid in chamber 16 may only act on the exposed portion of shuttle 40. Thus, to move from a fully closed position to an open position, a significant operating fluid overpressure may be required. For example, for a pressure set point of 100 psig (i.e., a control fluid pressure of 100 psig in chamber 46a), an operating fluid pressure of up to 500 psig may be required to move the shuttle assembly from the fully closed position. Such a pressure overshoot is undesirable.

Accordingly, there exists a need for a back pressure control system having a decreased pressure overshoot when moving from a fully closed position to avoid the creation of excessive back pressure.

### SUMMARY OF THE DISCLOSURE

In one aspect, embodiments disclosed herein relate to a fluid control system, including: a housing having an inlet, an outlet, and a pressure chamber; a shuttle assembly adapted to reciprocate in the pressure chamber to regulate the flow of an operating fluid from the inlet to the outlet; the operating fluid applying an opening force to a first end of the shuttle assembly; a control fluid to apply a closing force to an opposite end of the shuttle assembly; wherein an operating fluid pressure area of the first end of the shuttle assembly when in a closed position is at least 65 percent of the operating fluid pressure area of the first end of the shuttle assembly when in an open position.

In another aspect, embodiments disclosed herein relate to a fluid control system including: a housing having an inlet passage, an axial bore a portion of which forms an outlet passage, and a chamber; a shuttle assembly adapted for movement in the housing to control the flow of fluid from the inlet passage to the outlet passage, the fluid applying a force to a first end of the choke member; a source of control fluid connected to the chamber so that the control fluid applies an equal force on the opposite end of the shuttle assembly to control the position of the choke member in the housing in a manner to exert a back pressure on the fluid in the inlet passage; the shuttle assembly including a shuttle nut disposed proximate the first end for retaining shuttle assembly components, the shuttle nut including at least two surfaces providing operating fluid pressure area, the at least two surfaces including: a raised shoulder for engaging a seat member when the shuttle assembly is in a closed position and for providing operating fluid pressure area when the shuttle assembly is in an open position; at least one surface for providing operating fluid pressure area when the shuttle assembly is in either the open or closed position; wherein the operating fluid pressure area when the shuttle assembly is in the closed position is at least 65 percent of the operating fluid pressure area when the shuttle assembly is in the open position.

Other aspects and advantages will be apparent from the following description and the appended claims.

### BRIEF DESCRIPTION OF DRAWINGS

FIG. 1 is a schematic diagram of a prior art back pressure control system.

FIG. 2 is a schematic diagram of a fluid control system according to embodiments disclosed herein.

FIGS. 3a (top view), 3b (cross-section), and 3c (detail view) are schematic diagrams of a shuttle nut for a fluid control system according to embodiments disclosed herein.

FIG. 4 is a top view schematic diagram of a shuttle nut according to embodiments disclosed herein.

FIG. 5 is a schematic diagram of a fluid control system according to embodiments disclosed herein.

FIG. 6 is a graphical representation of a pressure overshoot that may be encountered with a prior art pressure control system.

FIG. 7 is a graphical representation of the minimal pressure overshoot that may be achieved with a pressure control system according to embodiments disclosed herein.

### DETAILED DESCRIPTION

In one aspect, embodiments disclosed herein relate to a fluid control system. In another aspect, embodiments disclosed herein relate to a back pressure control system having a low pressure overshoot when moving from a fully closed position to an open position. In another aspect, embodiments disclosed herein relate to a back pressure control system having a reduced contact area between upstream (dynamic) and downstream (static) components. In another aspect, embodiments disclosed herein relate to a back pressure control system having a decreased contact area between a shuttle nut and a static trim.

Fluid control systems useful in embodiments disclosed herein may include various dynamic and static components that interact during operation of the back pressure control system. The position of the dynamic components, similar to the back pressure control system of U.S. Pat. No. 6,253,787, may result based on the pressures of a control fluid and an operating fluid acting on opposite ends of the dynamic components. The manner in which the dynamic and static components interact when the choke is in a fully closed position has been found to have a profound impact on the operation of the back pressure control system. Specifically, it has been found that excessive contact area between dynamic components and static components may result in an excessive operating fluid pressure to cause an initial movement of the dynamic components from the fully closed position.

Embodiments of fluid control systems disclosed herein may provide for a decreased contact area between dynamic and static components when in a closed position. The decreased contact area may allow for additional surface area of the dynamic components to be exposed when the back pressure control system is in a closed position. This increases the surface area available for the operating fluid to act upon, thus more substantially balancing with the available surface area upon which the control fluid acts, decreasing the required operating fluid pressure to cause an initial movement of the dynamic components from the fully closed position.

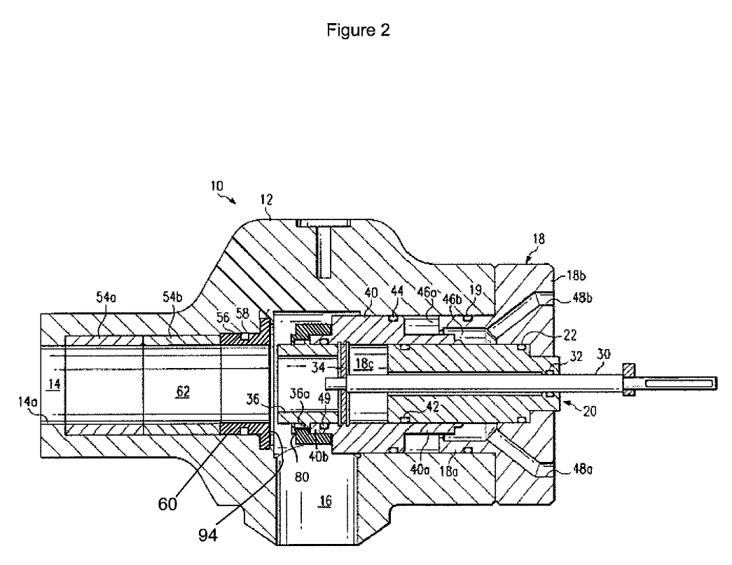

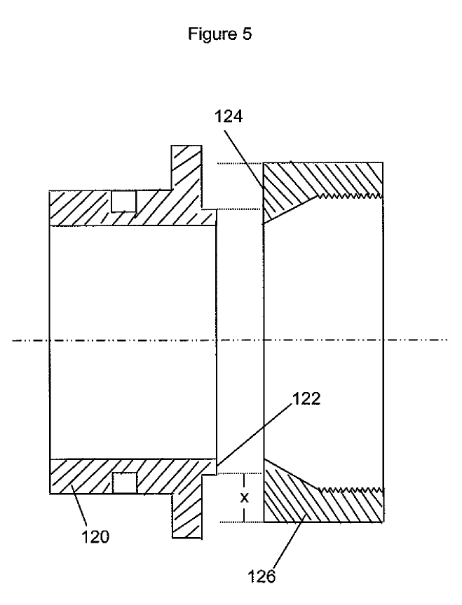

The decreased contact area between the dynamic and static components and the resulting decrease in pressure required to move the dynamic components from a closed position may be obtained by modifying one or more of the dynamic components and the static components according to embodiments disclosed herein. FIGS. 2-4 and the related text describe various modifications to dynamic components, namely the shuttle nut, according to embodiments disclosed herein. FIG. 5 and the related text describe modifications to static components, namely a valve seat or a static trim, according to embodiments disclosed herein.

In the broadest sense, fluid control systems according to embodiments disclosed herein may include a housing having an inlet, an outlet, and a pressure chamber. A shuttle assembly adapted to reciprocate in the pressure chamber may be used to regulate the flow of an operating fluid from the inlet to the outlet, where the operating fluid applies an opening force to a first end of the shuttle assembly. A control fluid may be used to apply a closing force to an opposite end of the shuttle assembly.

When in an open position, the operating fluid may apply a force to the first end of the shuttle assembly, where the entire surface area of the first end is available for the operating fluid to apply a force. When in a closed position, a portion of the first end of the shuttle assembly may be in surface-to-surface contact with a portion of the static components. The surface area of the first end of the shuttle assembly in contact with the static components is thus not available for the operating fluid to apply a force.

When in a closed position, for embodiments of fluid control systems described herein, an operating fluid pressure area of the first end of the shuttle assembly is a selected percentage of the operating fluid pressure area of the first end of the shuttle assembly when in an open position. As used herein, “fluid pressure area” is used to refer to the sum of all surface areas upon which the fluid, operating or control, may apply a component force parallel to the axis of movement of the shuttle assembly. The selected percentage may be such that a selected pressure greater than the control fluid pressure may be required to move the shuttle assembly from a fully closed position. For example, when in a fully closed position, for an operating fluid pressure area 75 percent that of the operating fluid pressure area when in an open position, a pressure approximately 33 percent greater than operating fluid pressure set point may be required to move the shuttle assembly from the closed position. In some embodiments, when in a fully closed position, the operating fluid pressure area of the first end of the shuttle assembly may have a selected percentage of the operating fluid pressure area when in an open position of at least 65 percent; between 65 and 98 percent in other embodiments; between 70 and 95 percent in other embodiments; between 75 and 92 percent in other embodiments; and between 80 and 90 percent in yet other embodiments.

When in an open position, the operating fluid pressure area of the first end of the shuttle assembly may be substantially equal to the control fluid pressure area of the opposite end of the shuttle assembly, thus maintaining an operating fluid pressure approximately equal to the pressure of the control fluid. Thus, the set point pressure for the control fluid may directly correlate to the pressure of the operating fluid.

The selected percentage for the operating fluid pressure area may be achieved by providing a raised shoulder, flow channels, or other similar features such that, when in a closed position, operating fluid may apply pressure to only a selected portion of the first end of the shuttle assembly, the operating fluid pressure area. The remaining area of the first end, when closed, may be in surface-to-surface contact with outlet components, such as a valve seat, a wear component or static trim, or a portion of the housing. In some embodiments, the raised shoulder or flow channels may be provided on the first end of the shuttle assembly. In other embodiments, the raised shoulder or flow channels may be provided on the outlet components. In yet other embodiments, both the first end of the shuttle assembly and the outlet components may include a raised shoulder or flow channels.

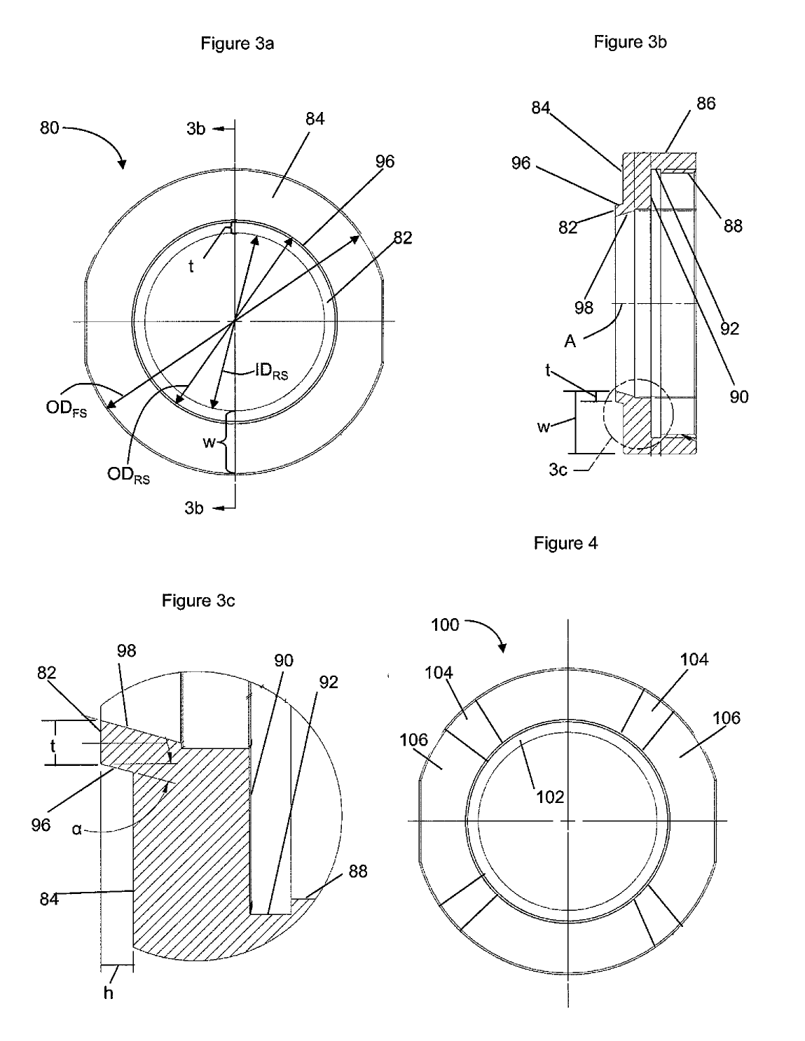

Various embodiments of the above described fluid control system are described below with respect to FIGS. 2-5. Referring now to FIG. 2, a fluid control system 10 having a shuttle nut 80, according to embodiments disclosed herein and detailed with respect to FIGS. 3a-3c, is illustrated. The fluid control system 10 includes a housing 12 having an axial bore 14 extending through its length and having a discharge end 14a. A radially extending inlet passage 16 is also formed in the housing 12 and intersects the bore 14. Connecting flanges (not shown) can be provided at the discharge end 14a of the bore 14 and at the inlet end of the passage 16 to connect them to appropriate flow lines. Drilling or formation fluid from a well is introduced into the inlet passage 16, passes through the housing 12 and normally discharges from the discharge end of the bore 14 for recirculation.

A bonnet 18 is secured to the end of the housing 12 opposite the discharge end 14a of the bore 14. The bonnet 18 is substantially T-shaped in cross section and has a cylindrical portion 18a extending into the bore 14 of the housing. A seal ring 19 extends in a groove formed in an outer surface of the bonnet portion 18a and engages a corresponding inner surface of the housing 12. The bonnet 18 also includes a cross portion 18b that extends perpendicular to the cylindrical portion 18a and is fastened to the corresponding end of the housing 12 in any conventional manner.

A mandrel 20 is secured in the end portion of the bonnet 18, and a seal ring 22 extends between the outer surface of the mandrel and the corresponding inner surface of the bonnet. A rod 30 is slidably mounted in an axial bore extending through the mandrel 20, and a seal ring 32 extends in a groove formed in the inner surface of the mandrel defining the latter bore. The seal ring 32 engages the outer surface of the rod 30 as the rod slides in the bore of the mandrel 20 under conditions to be described. One end portion of the rod 30 projects from the corresponding ends of the mandrel 20 and the bonnet 18, and the other end portion of the rod 30 projects from the other end of the mandrel 20 and into the bore 14.

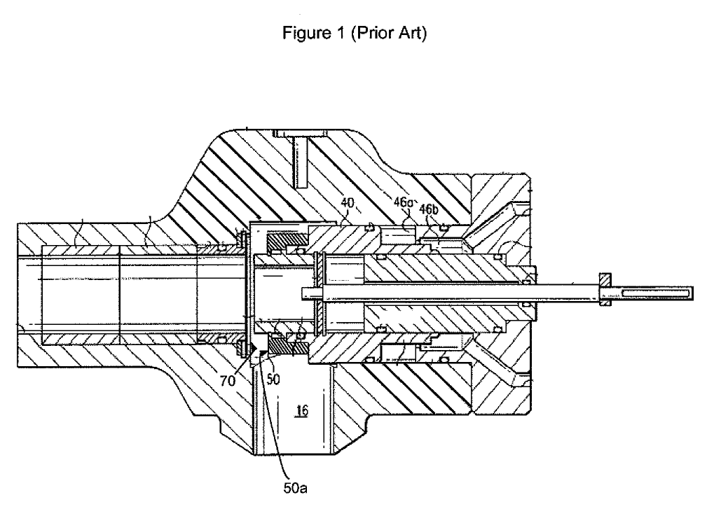

In some embodiments, a spacer 34 is mounted on the latter end of the rod 30 in any known manner and is captured between two snap rings 35a and 35b whose function will be described in detail later. A cylindrical choke member 36 is disposed in the bore 14 with one end abutting the spacer 34. The choke member 36 is shown in an operating position in FIG. 1 and extends in the intersection of the bore 14 with the inlet passage 16 to control the flow of fluid from the latter to the former, as will be described.

A cylindrical shuttle 40 is slidably mounted over the mandrel 20, and a seal ring 42 extends in a groove formed in an outer surface of the mandrel and engages a corresponding inner surface of the shuttle. Similarly, a seal ring 44 extends in a groove formed in an outer surface of the shuttle 40 and engages a corresponding inner surface of the housing 12. The shuttle 40 has a reduced-diameter portion 40a that defines, with the inner surface of the housing 12, a fluid chamber 46a. Another fluid chamber 46b is defined between the outer surface of the mandrel 20 and the corresponding inner surface of the bonnet portion 18a. The chambers 46a and 46b communicate and receive a control fluid from a passage 48a formed through the bonnet 18. It is understood that the passage 48a is connected to a hydraulic system (not shown) for circulating the control fluid into and from the passage. In this context the control fluid is introduced into the passage 48a, and therefore the chambers 46a and 46b, at a predetermined, desired set point pressure as determined by a set point pressure regulator and measured by a gauge located on an associated console. Since the pressure regulator, the gauge and the console are conventional they are not shown and will not be described in any further detail.

The control fluid enters the chambers 46a and 46b and acts against the corresponding exposed end portions of the shuttle 40. The shuttle 40 is designed to move so the force caused by the pressure of the control fluid from the chambers 46a and 46b at the predetermined set point pressure acting on the corresponding exposed end portions of the shuttle 40 is equal to the force caused by the pressure of the drilling or formation fluid in the passage 16 acting on the corresponding exposed end portions of the other end of the shuttle 40 and the shuttle nut 80. Thus, the shuttle 40 is normally in a balanced condition as will be described. A passage 48b is also formed through the bonnet portion 18 for bleeding air from the system through a bleed valve, or the like (not shown) before operation.

The shuttle 40 has an externally threaded, reduced-diameter, end portion 40b which extends over a portion of the choke member 36. A seal ring 49 extends in a groove formed in an inner surface of the end portion 40b and engages a corresponding outer surface of the choke member 36. An internally threaded shuttle nut 80, detailed in FIGS. 3a-3c, threadedly engages the end portion 40b of the shuttle 40 and extends over an annular flange 36a formed on the choke member 36, to capture the choke member on the shuttle 40. The shuttle 40, in some embodiments, also has two spaced grooves formed in its inner diameter for receiving the snap rings 35a and 35b. Therefore, axial movement of the shuttle 40 over the fixed mandrel 20 causes corresponding axial movement of the choke member 36, and therefore the spacer 34 and the rod 30.

Two cylindrical liners 54a and 54b are provided in the bore 14 downstream of its intersection with the passage 16. A choke seat 56 is also disposed in the bore upstream from the liner 54b, and a seal ring 58 extends in a groove formed in the outer surface of the choke seat and engages a corresponding portion of the inner surface of the housing 12. The choke seat 56 and, therefore, the liners 54a and 54b are retained in the bore 14 by a static trim member 60. The liners 54a and 54b and the choke seat 56 define a discharge passage 62 in the bore 14 of the housing 12 extending from the intersection of the bore 14 and the passage 16 to the discharge end 14a of the bore 14. The internal diameter of the choke seat 56 is sized relative to the outer diameter of the choke member 36 to receive same in a relatively tight fit.

Manufacture of specific components of the pressure control systems disclosed herein may vary from that described in relation to FIG. 2. For example, in some embodiments, mandrel 20 and bonnet 18 may be formed as a single part, thus eliminating the need for a seal ring 22. Additionally spacer 34 and shuttle 40 may be manufactured as a single part, thus eliminating a need for snap rings 35a and 35b. Other minor manufacturing differences with respect to components of the pressure control system may also be used without deviating from the scope of embodiments disclosed herein.

Referring to FIGS. 3a-3c, one embodiment of a shuttle nut 80, according to embodiments disclosed herein, is illustrated, where like numerals represent like parts. FIG. 3a is a top view of shuttle nut 80, which may include a raised shoulder 82 and a flanged surface 84. Referring now to FIG. 3b, as mentioned above, shuttle nut 80 includes a tubular portion 86, having an internal threaded section 88 that may treadedly engage the end portion of the shuttle 40. Internal flanged surface 90 may be used to extend over an annular flange formed on the choke member 36, so as to retain the choke member 36 in place during shuttling of the shuttle assembly. Groove 92 may be used to retain o-rings or other sealing elements between shuttle nut 80 and the choke member 36.

The total exposed surface area of the nut 80 having a component normal to the axis A of shuttle 40 movement; for example, surfaces normal to axis A and surfaces angled with respect to axis A, may allow for operating fluid in chamber 16 to apply a component force parallel to axis A. As illustrated in FIGS. 3b, raised shoulder 82, flanged surface 84, and tapered surface 96 may each provide for surface area upon which the operating fluid may act, imparting a force parallel to axis A. When the shuttle 40 is in an operating position, the entire surface area of the top face may be exposed and available for the operating fluid to act upon; when in a fully closed position, raised shoulder 82 may abut a downstream component, thus decreasing the total available surface area upon which the operating fluid may act. The pressure overshoot required to move the shuttle assembly from a fully closed position will decrease as the available surface area of the top face and other shuttle components approaches the amount of surface area upon which the control fluid may act on the other end of the shuttle 40.

Referring to FIGS. 2-3, when in a closed position, raised shoulder 82 may contact a portion of surface 94 of static trim 56, forming a surface-to-surface interface providing for closure of the back pressure control system, closing or severely restricting flow of operating fluid from chamber 16 to chamber 62. As known to those skilled in the art, debris, sand, grit, etc. in the operating fluid may damage surface 82 when closing against surface 94, which may limit the ability of the pressure control system to completely eliminate flow from chamber 16 to chamber 62.

Due to damage typically sustained by fluid control system components, it was previously believed that a large contact area between the static and dynamic components was required to maintain fluid control system operations, restricting fluid flow from chamber 16 to chamber 62, with a low wear rate or failure rate. However, operation of the fluid control system 10 may be sustained for extended periods, even with the reduced contact area in embodiments of the fluid control systems disclosed herein. The wear components, such as the static trim 56 and the shuttle nut 80, may be replaced after the wear is sufficient to hamper pressure control efficiency. In this manner, complete replacement of the back pressure control system is not necessary and only replacement of various components encountering wear is needed.

Referring again to FIGS. 3a and 3b, raised shoulder 82 may have a thickness t that may be defined as the outer diameter OD_{RS} of raised shoulder 82 minus the inner diameter ID_{RS} of raised shoulder 82. The total surface width w of the flanged surfaces 82, 84 may be defined as the outer diameter ODFs of flanged surface 84 minus the inner diameter ID_{RS} of raised shoulder 82.

The surface-to-surface contact area between raised shoulder 82 and surface 94 should be sufficient to provide for closure of the back pressure control system, yet should be sufficient to provide for wear while maintaining operability of the back pressure control system over the effective service life of the shuttle nut 80. Additionally, the contact area and exposed surface should provide for sufficient strength and integrity of the shuttle nut 80 and raised shoulder 82, such that the shuttle nut 80 and raised shoulder 82 may sustain repeated impact with the static trim during operation of the back pressure control system. In some embodiments, a ratio of the thickness t of the raised shoulder to the total width w of the flanged surfaces may range from 0.01 to 0.35; from 0.02 to 0.25 in other embodiments; from 0.03 to 0.2 in other embodiments; and from 0.05 to 0.1 in yet other embodiments. In this manner, sufficient surface area may be provided upon which the operating fluid may act, decreasing the pressure overshoot required to move the shuttle assembly from a fully closed position.

Referring now to FIG. 3c, raised shoulder 82 may extend a height h above flanged surface 84. Height h should also be sufficient to allow for some wear of shuttle nut 80 while maintaining a sufficient height above flanged surface 84. Excessive wear of raised shoulder 82 may result in a decrease of the surface-to-surface contact area between the shuttle nut 80 and the static trim 56, thus resulting in a decrease in the pressure required to move the shuttle assembly from a fully closed position. In some embodiments, height h may range from about 0.75 mm to about 6.5 mm (about 0.03 inches to about 0.25 inches), which may depend upon the overall size of the back pressure control system and the severity of service expected, among other variables. In other embodiments, height h may range from about 1.25 mm to about 5 mm (about 0.05 inches to about 0.2 inches); from about 2.5 mm to about 3.8 mm (about 0.1 inches to about 0.15 inches) in yet other embodiments.

As illustrated in FIGS. 3a-3c, the tubular extension of raised shoulder 82 from flanged surface 84 may be tapered with respect to axis A. For example, the top face of raised shoulder 82 may be tapered from raised shoulder 82 to flanged surface 84 along surface 96, where surface 96 may form an angle a with respect to axis A. Angle a may range from about 0° to about 30° in some embodiments; from about 5° to about 25° in other embodiments; from about 10° to about 20° in other embodiments; and about 15° in yet other embodiments. Surface 98 may form a similar angle with respect to axis A, which may be the same or different than that formed by surface 96. The taper used for surface 98 should correspond to the taper of an abutting external surface of the choke member 36 (see FIG. 2), or may be used to hold a seal, such as a TEFLON gasket, between the choke member 36 and the shuttle nut 80.

Similarly, referring now to FIG. 4, a top view of a shuttle nut or static trim having flow channels is illustrated. A shuttle nut 100, for example, may include a raised shoulder 102, similar to those as described above. In addition, additional raised surfaces 104 may be provided, of varied design and/or configuration, such that a flow channel 106 between additional raised surfaces 104 provide for operating fluid pressure area while the additional raised surfaces 104 limit the operating fluid pressure area when the shuttle assembly is in the closed position. Although illustrated where the additional surfaces are projecting outward from raised shoulder 102, other designs providing for a flow area and limiting the operating fluid pressure area are also considered such as a spiral design or a random placement of raised surfaces.

Although illustrated above with respect to a raised shoulder on a shuttle nut, a decrease in the area of contact between the static trim and a shuttle nut may be attained by modifying the static trim. Referring now to FIG. 5, a static trim 120 may include a raised shoulder 122. When in a fully closed position, top face 124 of a shuttle nut 126 may contact raised shoulder 122 of static trim 120, thus allowing for the operating fluid in chamber 16 to act upon the remaining portion of top face 124, such as over the surface area of exposed thickness x.

As described in relation to FIGS. 2-5, raised surfaces provided on either the shuttle assembly, such as on the shuttle nut, or on outlet components, such as the static trim, may be used to decrease the contact area between the shuttle assembly and the outlet components, providing for additional surface area on which the operating fluid may act, reducing the pressure overshoot required to move the shuttle assembly from a filly closed position. Other embodiments of the present disclosure may include various designs of the component parts to result in additional shuttle nut surface area upon which the operating fluid may act, reducing the pressure overshoot. For example, raised shoulders may be provided on both the shuttle nut and the static trim. As another example, the shuttle nut may abut downstream components other than a static trim, such as a choke seat, when in the fully closed position; in such an instance, the design of one or both the downstream component and the shuttle nut may be modified to provide the additional shuttle nut surface area. Regardless of actual design, as described above, when in a fully closed position, the available operating fluid pressure area upon which the operating fluid may apply a component force parallel to the axis of the shuttle movement results in a decrease in the pressure overshoot required to move the shuttle from a fully closed position.

### EXAMPLE

Performance of a back pressure control system according to embodiments disclosed herein, including a raised shoulder and increased exposed surface area when in a fully closed position, is compared to a prior art pressure control system, similar to that illustrated in FIG. 1. In response to changes in various drilling parameters, a change in the set point for the back pressure to be maintained by the pressure control system is sometimes required to maintain the bottom hole pressure above a desired minimum, such as 400 psig.

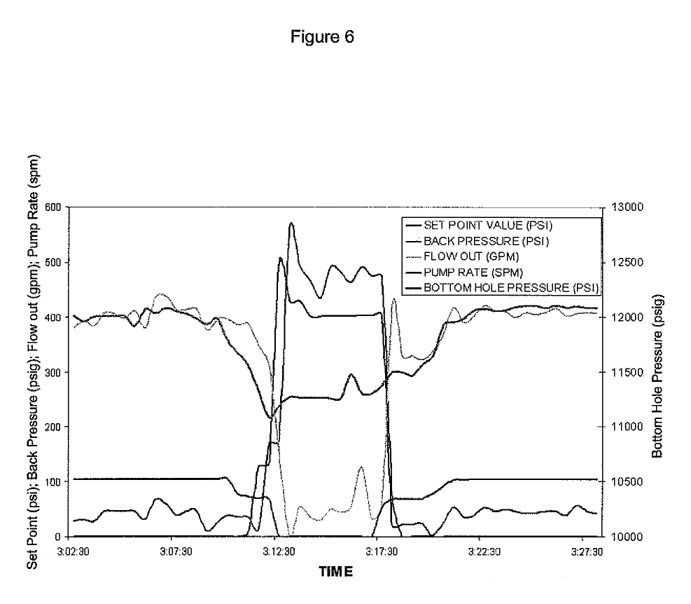

Referring now to FIG. 6, the back pressure set point for a prior art pressure control system is increased initially from about 0 psig to about 120 psig, thus forcing the shuttle to a fully closed position. The system back pressure increases as a result, lagging slightly behind the change in set point value. A further change in set point value is required, and increasing the set point from 120 psig to about 420 psig results in the back pressure overshooting by approximately 80 psi.

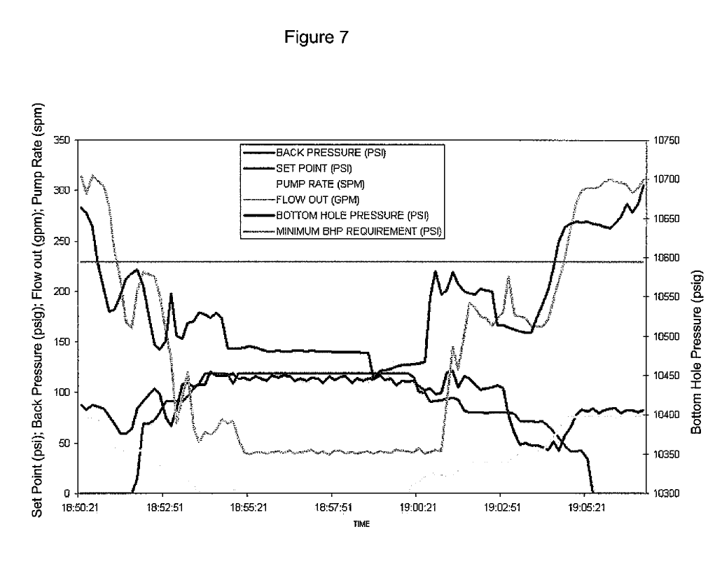

Referring now to FIG. 7, the back pressure set point for a pressure control system according to embodiments disclosed herein is increased from about 0 psig to about 120 psig, thus forcing the shuttle to a fully closed position. The system back pressure increases as a result, lagging slightly behind the change in set point value. However, in contrast to the prior art pressure control system in FIG. 6, only a minimal overshoot in back pressure is observed with the pressure control system according to embodiments disclosed herein.

As described above, embodiments of the back pressure control systems disclosed herein may provide for a decreased contact area between upstream (dynamic) and downstream (static) components when in a closed position. Advantageously, embodiments disclosed herein may provide for a decrease in the pressure required to initially open the back pressure control system from a fully closed position. The resulting decrease in required pressure may provide for improved operability of processes fluidly connected to fluid control systems according to embodiments disclosed herein.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed:

1. A fluid control system, comprising:
a housing having an inlet, an outlet, and a pressure chamber;
a shuttle assembly adapted to reciprocate in the pressure chamber to regulate the flow of an operating fluid from the inlet to the outlet;
the operating fluid applying an opening force to a first end of the shuttle assembly;
a control fluid to apply a closing force to an opposite end of the shuttle assembly;
wherein an operating fluid pressure area of the first end of the shuttle assembly when in a closed position is at least 65 percent of the operating fluid pressure area of the first end of the shuttle assembly when in an open position.

2. The fluid control system of claim 1, wherein, when in an open position, the operating fluid pressure area of the first end of the shuttle assembly is substantially equal to a control fluid pressure area of the opposite end of the shuttle assembly.

3. The fluid control system of claim 1, wherein an operating fluid pressure area of the first end of the shuttle assembly when in a closed position is between 70 and 95 percent of the operating fluid pressure area of the first end of the shuttle assembly when in an open position.

4. The fluid control system of claim 1, wherein an operating fluid pressure area of the first end of the shuttle assembly when in a closed position is between 80 and 90 percent of the operating fluid pressure area of the first end of the shuttle assembly when in an open position.

5. The fluid control system of claim 1, wherein the first end of the shuttle assembly comprises a raised shoulder to engage a valve seat.

6. The fluid control system of claim 5, wherein the first end of the shuttle assembly further comprises at least one of a flow channel and an additional raised surface.

7. The fluid control system of claim 5, wherein a ratio of a thickness t of the raised shoulder to a width w of the operating fluid pressure area is within the range from 0.01 to 0.35.

8. The fluid control system of claim 1, wherein the housing comprises a valve seat having a raised shoulder to engage the first end.

9. The fluid control system of claim 8, wherein the valve seat comprises a wear component disposed in at least a portion of the outlet.

10. A fluid control system comprising:
a housing having an inlet passage, an axial bore a portion of which forms an outlet passage, and a chamber;
a shuttle assembly adapted for movement in the housing to control the flow of fluid from the inlet passage to the outlet passage, the fluid applying a force to a first end of the choke member;
a source of control fluid connected to the chamber so that the control fluid applies an equal force on the opposite end of the shuttle assembly to control the position of the choke member in the housing in a manner to exert a back pressure on the fluid in the inlet passage;
the shuttle assembly comprising a shuttle nut disposed proximate the first end for retaining shuttle assembly components,
the shuttle nut comprising at least two surfaces providing operating fluid pressure area, the at least two surfaces comprising:
a raised shoulder for engaging a seat member when the shuttle assembly is in a closed position and for providing operating fluid pressure area when the shuttle assembly is in an open position;
at least one surface for providing operating fluid pressure area when the shuttle assembly is in either the open or closed position;
wherein the operating fluid pressure area when the shuttle assembly is in the closed position is at least 65 percent of the operating fluid pressure area when the shuttle assembly is in the open position.

11. The fluid control system of claim 10, wherein, when in an open position, the operating fluid pressure area of the first end of the shuttle assembly is substantially equal to a control fluid pressure area of the opposite end of the shuttle assembly.

12. The fluid control system of claim 10, wherein an operating fluid pressure area of the first end of the shuttle assembly when in a closed position is between 70 and 95 percent of the position.

13. The fluid control system of claim 10, wherein an operating fluid pressure area of the first end of the shuttle assembly when in a closed position is between 80 and 90 percent of the operating fluid pressure area of the first end of the shuttle assembly when in an open position.

14. The fluid control system of claim 10, wherein the at least one surface for providing operating fluid pressure area further comprises at least one raised surface and at least one flow channel.

15. The fluid control system of claim 10, wherein a ratio of a thickness t of the raised shoulder to a width w of the operating fluid pressure area is within the range from 0.01 to 0.35.
